(19) United States
(12) Patent Application Publication
(10) Pub. No.: US 2012/0039276 A1
(43) Pub. Date: Feb. 16, 2012

(54) METHOD AND APPARATUS FOR HARQ FEEDBACK TRANSMISSION IN A WIRELESS COMMUNICATION SYSTEM

(76) Inventor: Ming-Che Li, Taipei (TW)

(21) Appl. No.: 13/207,036

(22) Filed: Aug. 10, 2011

Related U.S. Application Data
(60) Provisional application No. 61/372,877, filed on Aug. 12, 2010.

(51) Int. Cl. H04W 72/04

(52) U.S. Cl. 370/329

(57) ABSTRACT

A method and apparatus for transmitting Acknowledgement/Non-Acknowledgement (ACK/NACK) and periodic channel status reporting in a wireless communication system includes configuring carrier aggregation, wherein Discrete Fourier Transform-Spread-Orthogonal Frequency Division Multiple Access (DFT-S-OFDM) serves as UpLink (UL) ACK/NACK transmission scheme, periodic channel status reporting and UL ACK/NACK coincide in a same subframe, and a Quadrature Phase Shift Keying (QPSK) modulation scheme with 24 QPSK symbols is used, carrying UL ACK/NACK feedback with a part of the 24 QPSK symbols in DFT-S-OFDM scheme, and carrying the periodic channel status reporting with the remaining part of the 24 QPSK symbols.

### CROSS-REFERENCE TO RELATED APPLICATIONS

The present Application claims the benefit of U.S. Provisional Patent Application Ser. No. 61/372,877, filed on Aug. 12, 2010, the entire disclosure of which is expressly incorporated herein by reference.

### FIELD

This disclosure generally relates to wireless communication networks, and more particularly, to a method and apparatus for Hybrid Automatic Repeat Request (HARQ) feedback transmission in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

According to one aspect, a method of transmitting Acknowledgement/Negative-Acknowledgement (ACK/NACK) and periodic channel status reporting in a wireless communication system includes configuring carrier aggregation, wherein DFT-S-OFDM serves as UpLink (UL) ACK/NACK transmission scheme, periodic channel status reporting and CL ACK/NACK coincide in a same subframe, and a Quadrature Phase Shift Keying (QPSK) modulation scheme with 24 QPSK symbols is used. The method further includes carrying UL ACK/NACK feedback with a part of the 24 QPSK symbols in DFT-S-OFDM scheme, and carrying the periodic channel status reporting with the remaining part of the 24 QPSK symbols.

According to another aspect, a communication device for use in a wireless communication system includes a control circuit, a processor installed in the control circuit for executing a program code to command the control circuit; and a memory installed in the control circuit and coupled to the processor. To transmit ACK/NACK and periodic channel status reporting, the processor is configured to execute a program code stored in memory to configure carrier aggregation, wherein DFT-S-OFDM serves as UL ACK/NACK transmission scheme, periodic channel status reporting and UL ACK/NACK coincide in a same subframe, and a Quadrature Phase Shift Keying (QPSK) modulation scheme With 24 QPSK symbols is used; and carry UL ACK/NACK feedback with a part of the 24 QPSK symbols in DFT-S-OFDM scheme, and carry the periodic channel status reporting with the remaining part of the 24 QPSK symbols.

### BRIEF DESCRIPTION OF THE DRAWINGS

FIG. 1 shows a diagram of a wireless communication system according to one exemplary embodiment.

FIG. 2 shows a user plane protocol stack of the wireless communication system of FIG. 1 according to one exemplary embodiment.

FIG. 3 shows a control plane protocol stack of the wireless communication system of FIG. 1 according to one exemplary embodiment.

FIG. 4 is a block diagram of a transmitter system (also known as access network) and a receiver system (also known as user equipment or UE) according to one exemplary embodiment.

FIG. 5 is a functional block diagram of a UE according to one exemplary embodiment.

FIG. 6 shows a block diagram of the structure for DFT-S-OFDM.

FIG. 7 is a method of Hybrid Automatic Repeat Request (HARQ) feedback transmission in a wireless communication system according to one embodiment.

FIG. 8 is a method of HARQ feedback transmission in a wireless communication system according to another embodiment.

FIG. 9 is a method of HARQ feedback transmission in a wireless communication sys according to another embodiment.

FIG. 10 is a method of HARQ feedback transmission in a wireless communication system according to another embodiment.

FIG. 11 is a method of HARQ feedback transmission in a wireless communication system according to another embodiment.

FIG. 12 is a method of HARQ feedback transmission in a wireless communication system according to another embodiment.

FIG. 13 is a method of HARQ feedback transmission in a wireless communication system according to another embodiment.

FIG. 14 is a method of HARQ feedback transmission in a wireless communication system according to another embodiment.

FIG. 15 is a method of HARQ feedback transmission in a wireless communication system according to another embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced), 3GPP2 UMB (Ultra Mobile Broadband). WiMax, or some other modulation techniques.

In particular. The exemplary wireless communication systems devices described below may be designed to support one or more standards such as the standard offered by a consortium named “3rd Generation Partnership Project” referred to herein as 3GPP, including Document Nos. 3GPP TS 36.211. V.9.1.0, “Physical Channels and Modulation (Release 9).” 3GPP TS 36.212 V.9.2.0, “E-UTRA Multiplexing and Channel Coding (Release 9).” and 3GPP IS 36.213 V9.2.0, “E-UTRA Physical Layer Procedures (Release 9).” The standards and documents listed above are expressly incorporated herein by reference.

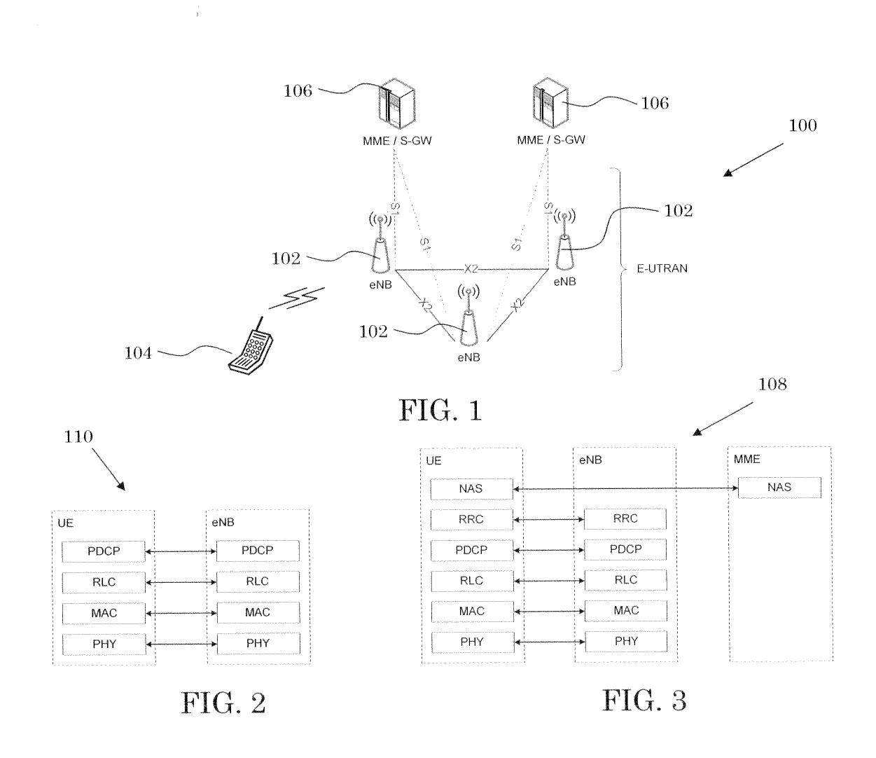

An exemplary network structure of an Evolved Universal Terrestrial Radio Access Network (E-UTRAN) 100 as a mobile communication system is shown in FIG. 1 according to one exemplary embodiment. The E-UTRAN system can also be referred to as a LTE (Long-Term Evolution) system or LTE-A (Long-Term Evolution Advanced). The E-UTRAN generally includes eNode B or eNB 102, which function similar to a base station in a mobile voice communication network. Each eNB is connected by X2 interfaces. The eNBs are connected to terminals or user equipment (UE) 104 through a radio interface, and are connected to Mobility Management Entities (MME) or Serving Gateway (S-GW) 106 through SI interfaces.

Referring to FIGS. 2 and 3, the LTE system is divided into control plane 108 protocol stack (shown in FIG. 3) and user plane 110 protocol stack (shown in FIG. 2) according to one exemplary embodiment. The control plane performs a function of exchanging a control signal between a UE and an eNB and the user plane performs a function of transmitting user data between the UE and the eNB. Referring to FIGS. 2 and 3, both the control plane and the user plane include a Packet Data Convergence Protocol (PDCP) layer, a Radio Link Control (RLC) layer, a Medium Access Control (MAC) layer and a physical (PHY) layer. The control plane additionally includes a Radio Resource Control (RRC) layer. The control plane also includes a Network Access Stratum (NAS) layer, which performs among other things including Evolved Packet System (EPS) bearer management, authentication, and security control.

The PHY layer provides information transmission service using a radio transmission technology and corresponds to a first layer of an open system interconnection (OSI) layer. The PHY layer is connected to the MAC layer through a transport channel. Data exchange between the MAC layer and the PRY layer is performed through the transport channel. The transport channel is defined by a scheme through which specific data are processed in the PHY layer.

The MAC layer performs the function of sending data transmitted from a RLC layer through a logical channel to the PHY layer through a proper transport channel and further performs the function of sending data transmitted from the PRY layer through a transport channel to the RLC layer through a proper logical channel. Further, the MAC layer inserts additional information into data received through the logical channel, analyzes the inserted additional information from data received through the transport channel to perform a proper operation and controls a random access operation.

The MAC layer and the RLC layer are connected to each other through a logical channel. The RLC layer controls the setting and release of a logical channel and may operate in one of an acknowledged mode (AM) operation mode, an unacknowledged mode (UM) operation mode and a transparent mode (TM) operation mode. Generally, the RLC layer divides Service Data Unit (SDU) sent from an upper layer at a proper size and vice versa. Further, the RLC layer takes charge of an error correction function through an automatic retransmission request (ARQ).

The PDCP layer is disposed above the RLC layer and performs a header compression function of data transmitted in an IP packet form and a function of transmitting data without loss even when a Radio Network Controller (RNC) providing a service changes due to the movement of a UE.

The RRC layer is only defined in the control plane. The RRC layer controls logical channels, transport channels and physical channels in relation to establishment, re-configuration and release of Radio Bearers (RBs). Here, the RB signifies a service provided by the second layer of an OSI layer for data transmissions between the terminal and the E-UTRAN. If an RRC connection is established between the RRC layer of a UE and the RRC layer of the radio network, the UE is in the RRC connected mode. Otherwise, the UE is in an RRC idle mode.

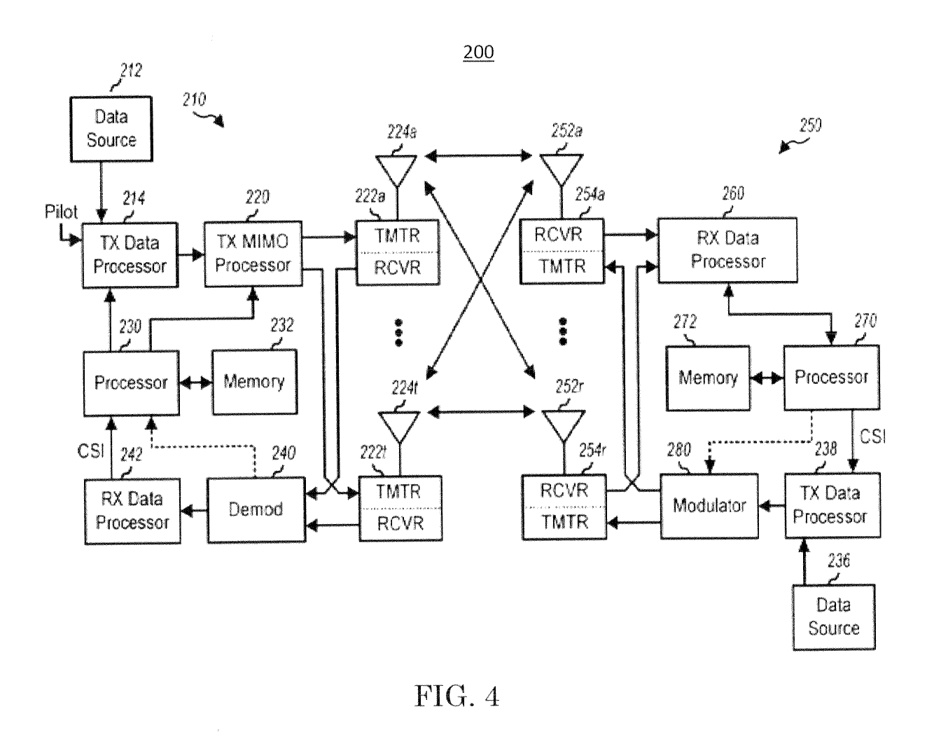

FIG. 4 is a simplified block diagram of an exemplary embodiment of a transmitter system 210 (also known as the access network) and a receiver system 250 (also known as access terminal or UE in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.+

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beam forming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel, N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and down-converts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, de-interleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beam-forming weights then processes the extracted message.

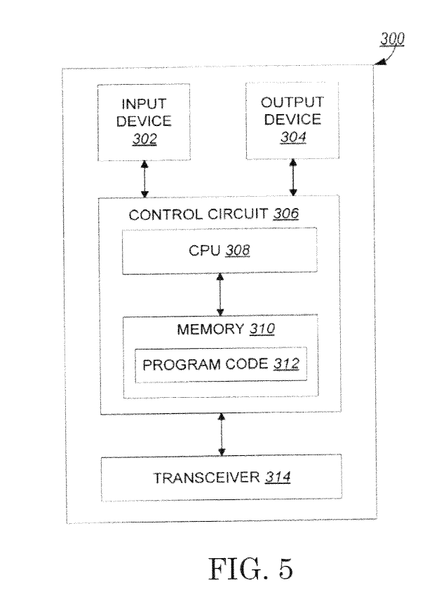

Turning to FIG. 5, this figure shows an alternative simplified functional block diagram of a communication device according to one exemplary embodiment. The communication device 300 in a wireless communication system can be utilized for realizing the UE 104 in FIG. 1, and the wireless communications system is preferably the LTE system, the LTE-A system or the like. The communication device 300 may include an input device 302, an output device 304, a control circuit 306, a central processing unit (CPU) 308, a memory 310, a program code 312, and a transceiver 314. The program code 312 includes the application layers and the layers of the control plane 108 and layers of user plane 110 as discussed above except the PHY layer. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

The LTE DownLink (DL) transmission scheme is based on Orthogonal Frequency Division Multiple Access (OFDMA), and the LTE UpLink (UL) transmission scheme is based on Single-Carrier (SC) Discrete Fourier Transform (DFT)-spread OFDMA (DFT-S-OFDMA) or equivalently, Single Carrier Frequency Division Multiple Access (SC-FDMA). LTE-Advanced (LTE-A), however, is designed to meet higher bandwidth requirements both in the DL and UL directions. In order to provide the higher bandwidth requirements, LTE-A utilizes component carrier aggregation. A user equipment (UE) with reception and/or transmission capabilities for carrier aggregation (CA) can simultaneously receive and/or transmit on multiple component carriers (CCs). A carrier may be defined by a bandwidth and a center frequency.

There are several physical control channels used in the physical layer that are relevant to CA operations. A physical downlink control channel (PDCCH) may inform the UE about the resource allocation of paging channel (PCH) and downlink shared channel (DL-SCH), and hybrid automatic repeat request (HARQ) information related to DL-SCH. The PDCCH may carry the uplink scheduling grant which informs the UE about resource allocation of uplink transmission. A physical control format indicator channel (PCFICH) informs the UE about the number of OFDM symbols used for the PDCCHs and is transmitted in every subframe. A physical Hybrid ARQ Indicator Channel (PHICH) carries HARQ ACK/NAK signals in response to uplink transmissions. A physical uplink control channel (PUCCH) carries uplink control information such as HARQ ACK/NAK in response to downlink transmission, scheduling request and channel quality indicator (CQI). A physical uplink shared channel (PUSCH) carries uplink shared channel (UL-SCH).

Carriers may be divided into a primary component carrier (PCC) and a secondary component carrier (SCC). The PCC refers to a carrier that is constantly activated, and the SCC refers to a carrier that may be activated or deactivated according to particular conditions. Activation means that transmission or reception of traffic data may be performed or traffic data is ready for its transmission or reception on the concerned CC. Deactivation means that transmission or reception of traffic data is not permitted on the concerned CC. The UE uses only a single PCC or one or more SCCs along with the PCC.

A PCC is used by an eNB to exchange traffic and PHY/MAC control signaling with a UE. SCCs are additional carriers which the UE may use for traffic, only per eNB specific commands and rules received on the PCC. The PCC may be a fully configured carrier, by which major control information is exchanged between the eNB and the UE. The PCC may be used for entering of the UE into a network or for an allocation of the SCC. The PCC may be selected from among fully configured carriers, rather than being fixed to a particular carrier.

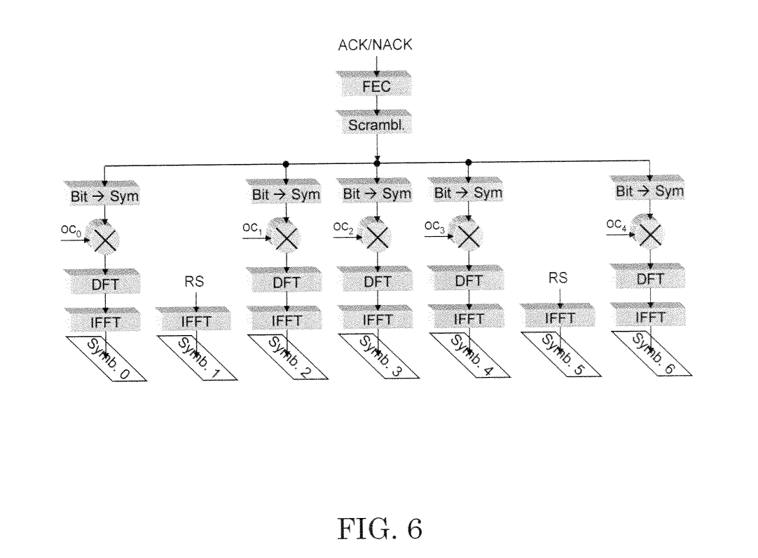

In LTE-A, large size of DL HARQ feedback on PUCCH is expected due to CA and the design of PUCCH only on the PCC. Two schemes have been adopted for high payload feedback, which are channel selection and DFT-S-OFDM. Channel selection already serves as ACK/NACK feedback scheme on PUCCH in LTE Rel-8 Time Division Duplex (TDD). The eNB can detect the ACK/NACK for multiple transport blocks based on the resource PUCCH utilized as well as the content on the PUCCH. The structure of DFT-S-OFDM is expressed in FIG. 6. Multiple ACK/NACK bits are first coded with a (32, O) block code by multiplying a coding matrix formed by basis sequences and rate matched to 48 bits. Depending on the HARQ feedback of corresponding transport block, the basis sequence may be present or absent in the output sequence. After modulation, 12 of 24 Quadrature Phase Shift Keying (QPSK) symbols are carried on the 12 Resource Elements (REs) of each SC-FDMA symbols without Reference Signal (RS) in the first slot, and the other half of the QPSK symbols are carried on the SC-FDMA symbols in the second slot. Orthogonal sequences are introduced to provide multiplexing capacity for different UEs.

Because of high payload size, good geometry is required for eNB to successfully decode corresponding HARQ feedbacks. One solution may be to reduce the payload size when UE is power-limited. Another solution may be to bundle the ACK/NACK bits across carriers resulting in one or two bits. Further bundling on spatial domain can be considered if Downlink Assignment Index (DAI) is not included and the PUCCH is required to reflect the number of received downlink assignment. Yet another solution is to utilize the resource implicit indicated by the PDCCH for downlink assignment transmitted on PCC and Discontinuous Transmission (DTX) when such PDCCH is not available. In this situation, the same PUCCH scheme can be reused when there is only downlink assignment for PCC.

In LTE, because simultaneous PUSCH and PUCCH transmission is not supported, ACK/NACK bits will be multiplexed onto PUSCH if there is uplink grant available. The code rate for multiplexed ACK/NACK depends on the reference code rate of data and also an offset value to guarantee the quality of ACK/NACK. Up to 4 SC-FDMA symbols can be utilized for ACK/NACK transmission.

In LTE, to support closed-loop spatial multiplexing in the downlink, the UE needs to feedback the Rank Indicator (RI), the Precoding Matrix Indicator (PMI), and the Channel Quality Indicator (CQI) in the uplink. With the Channel Quality Indicator (CQI), the transmitter selects one of a number of modulation alphabet and code rate combinations. The Rank Indicator (RI) informs the transmitter about the number of useful transmission layers for the current MIMO channel, and the Precoding Matrix Indicator (PMI) signals the codebook index of the precoding matrix that should be applied at the transmitter.

In LTE, in case of collision between CQI/PMI/RI and ACK/NACK in a same subframe, CQI/PMI/RI is dropped if the parameter simultaneousAckNackCQI provided by higher layers is set to FALSE. Otherwise, CQI/PMI/RI is multiplexed with ACK/NACK. When periodic CQI/PMI/RI reporting and ACK/NACK are multiplexed on PUCCH, the ACK/NACK bits are jointly encoded with CQI/PMI/RI bits using a (20, O) block code as extended Cyclic Prefix (CP) is configured, or are encoded in the generation of reference signal as normal CP is configured.

Since the large size of ACK/NACK feedback on PUCCH is expected because of CA, it is improper to directly use the method in LTE to transmit both CQI/PMI/RI and ACK/NACK simultaneously. A natural approach is to jointly encode CQI/PMI/RI and ACK/NACK bits and then transmit the encoded bits via the DFT-S-OFDM scheme. Accordingly, there would be one input stream including both ACK/NACK and CQI/PMI/RI, and one output stream after encoding of one block code. However, this approach requires to design a new block code to accommodate larger payload size of both CQI/PMI/RI and ACK/NACK bits since currently existing (32, O) block code and (20, O) block code are not suitable.

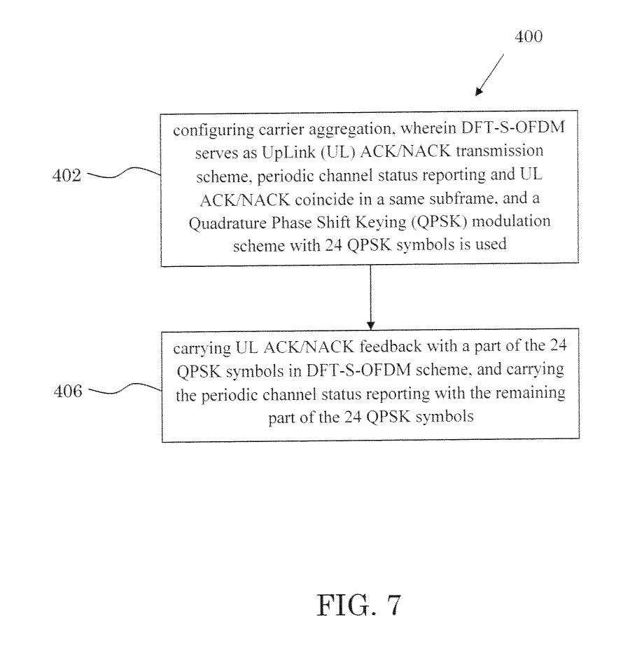

Referring to FIG. 7, a method 400 of transmitting ACK/NACK and periodic channel status reporting in a wireless communication system according to one embodiment is shown. The method includes configuring carrier aggregation at 402, where DFT-S-OFDM serves as UL ACK/NACK transmission scheme, periodic channel status reporting and UL ACK/NACK coincide in the same subframe, and a Quadrature Phase Shift Keying (QPSK) modulation scheme with 24 QPSK symbols is used. The method includes at 406 carrying the UL ACK/NACK feedback with a part of the 24 QPSK symbols in DFT-S-OFDM scheme, and carrying the periodic channel status reporting with the remaining symbols of the 24 QPSK symbols. According to the method of FIG. 7, both CQI/PMI/RI and ACK/NACK feedback can be encoded and then transmitted simultaneously. The CQI/PMI/RI bits use one channel block code and the ACK/NACK feedback bits use one channel block code. The encoded bits are transmitted simultaneously via the DFT-S-OFDM scheme. Accordingly, there are two input streams, one of which is ACK/NACK and the other of which is CQI/PMI/RI, and two corresponding output streams after separately encoding two block codes. Therefore, the methods described herein allow the LTE channel coding scheme to be reutilized for CQI/PMI/RI and ACK/NACK feedback multiplexing regardless of the larger payload sizes of both CQI/PMI/RI and ACK/NACK bits.

Referring back to FIG. 5, which is a functional block diagram of a UE according to one embodiment, the UE 300 includes a program code 312 stored in memory 310. The CPU 308 executes the program code 312 to perform the method 400 described above and those described below including carrying the UL ACK/NACK feedback with part of the 24 QPSK symbols in DFT-S-OFDM scheme and carrying the periodic channel status reporting with the remaining symbols of the 24 QPSK symbols.

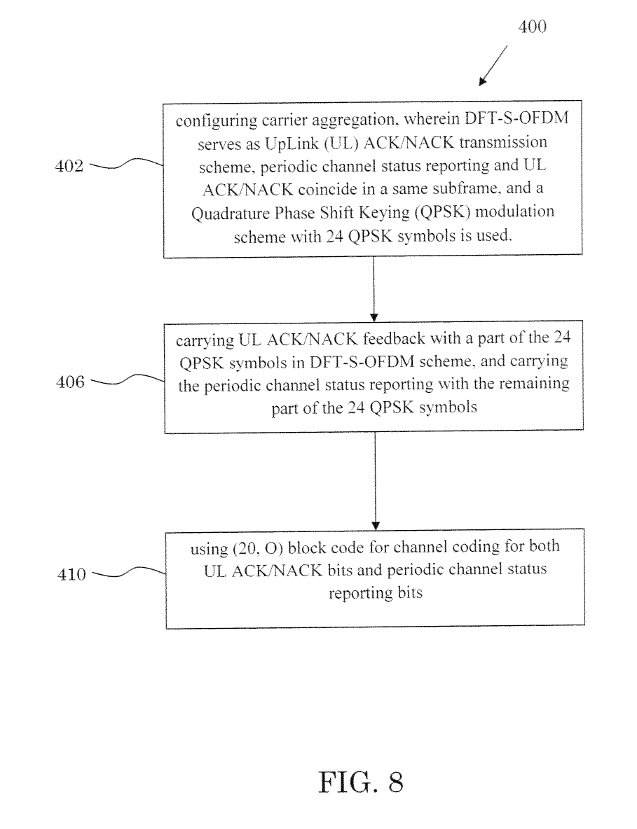

In another embodiment shown in FIG. 8, the method 400 further includes at 410, using (20, O) block code for channel coding for both UL ACK/NACK bits and periodic channel status reporting bits.

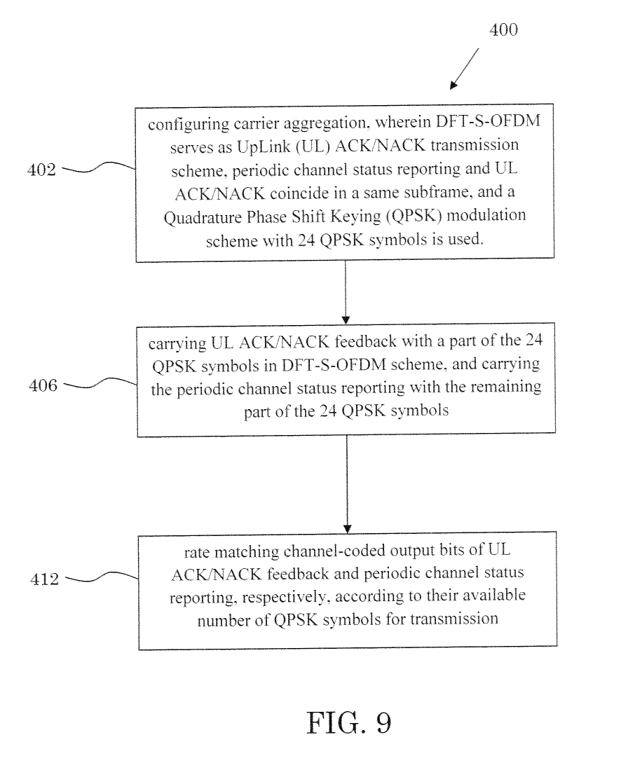

In another embodiment shown in FIG. 9, the method 400 further includes at 412, rate matching the channel-coded output bits of UL ACK/NACK and periodic channel status reporting, respectively, according to their available number QPSK symbols for transmission.

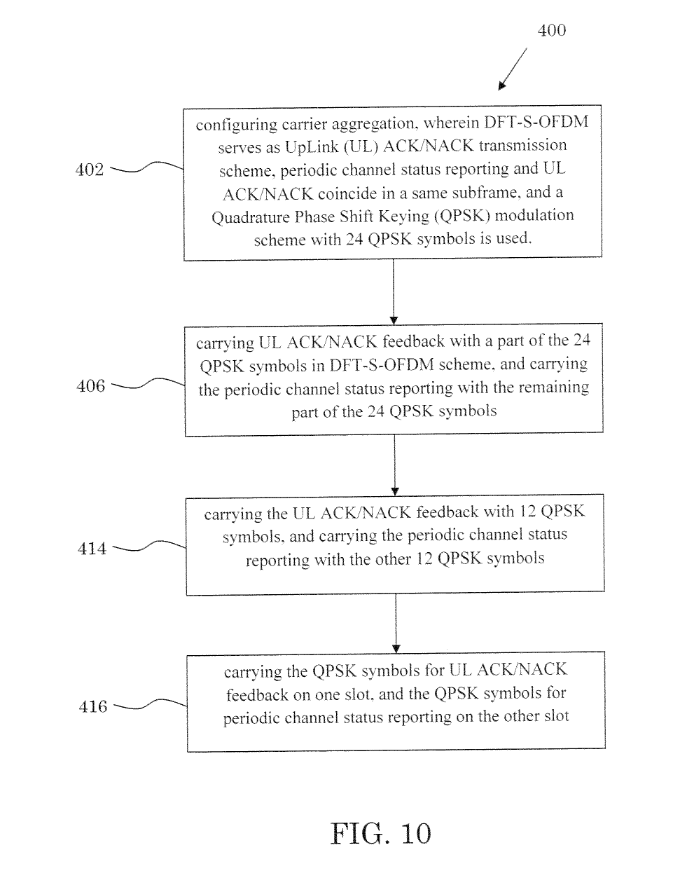

In another embodiment shown in FIG. 10, the method includes at 414, carrying the UL; ACK/NACK feedback with 12 QPSK symbols, and carrying the periodic channel status reporting with the other 12 QPSK symbols. Further, the method 400 includes at 416, carrying the QPSK symbols for UL ACK/NACK feedback on one slot, and the QPSK symbols for periodic channel status reporting on the other slot.

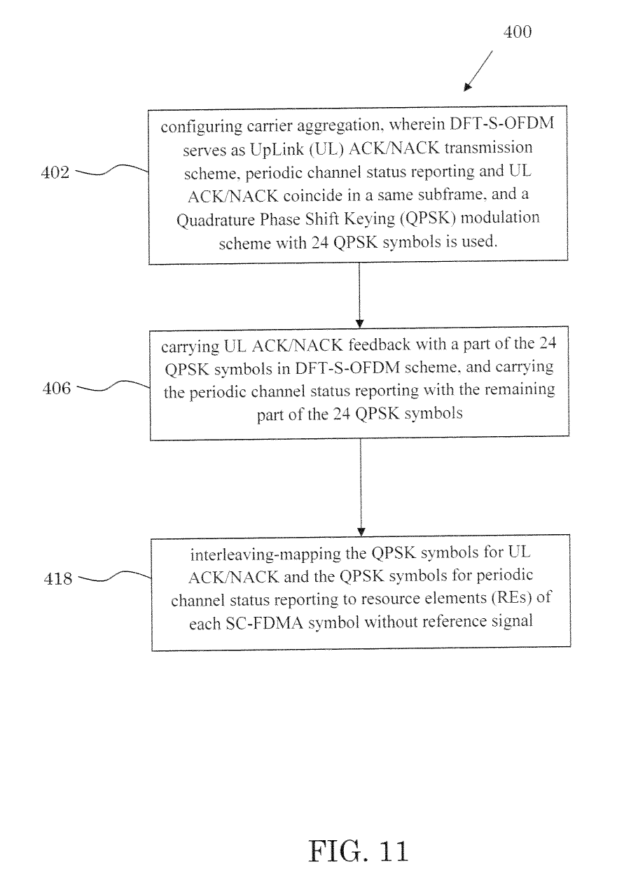

In another embodiment shown in FIG. 11, the method includes at 418, interleaving-mapping the two sets of QPSK symbols for UL ACK/NACK and periodic channel status reporting to resource elements (REs) of each SC-FDMA symbol without reference signal.

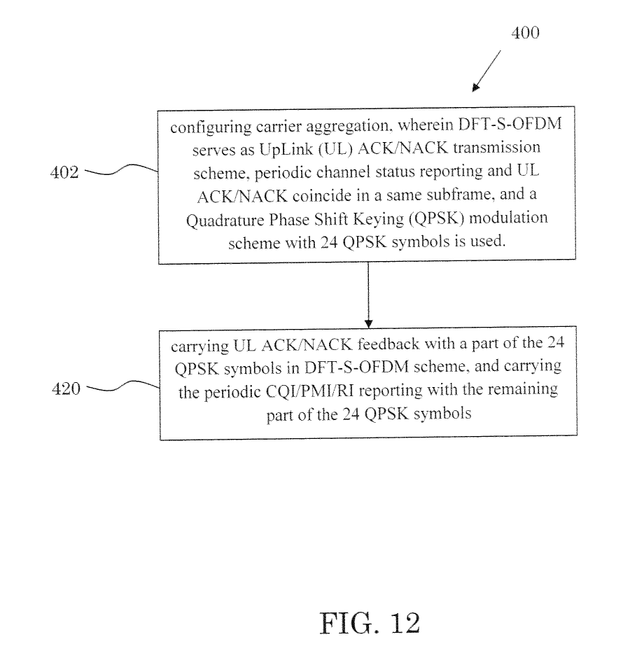

In another embodiment, the channel status reporting is defined as CQI/PMI/RI reporting as shown at 420 in FIG. 12.

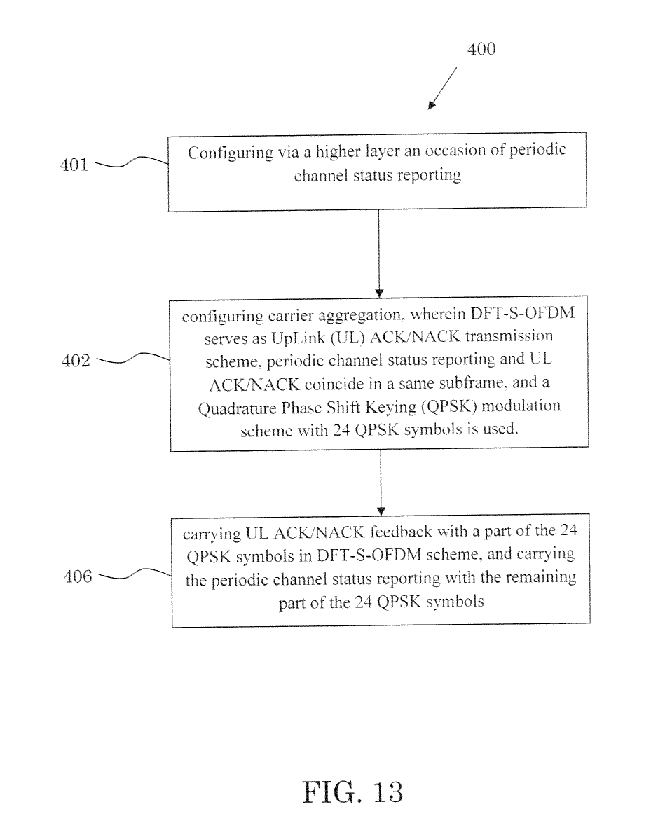

In another embodiment shown in FIG. 13, the method includes at 401, configuring via a higher layer an occasion of periodic channel status reporting.

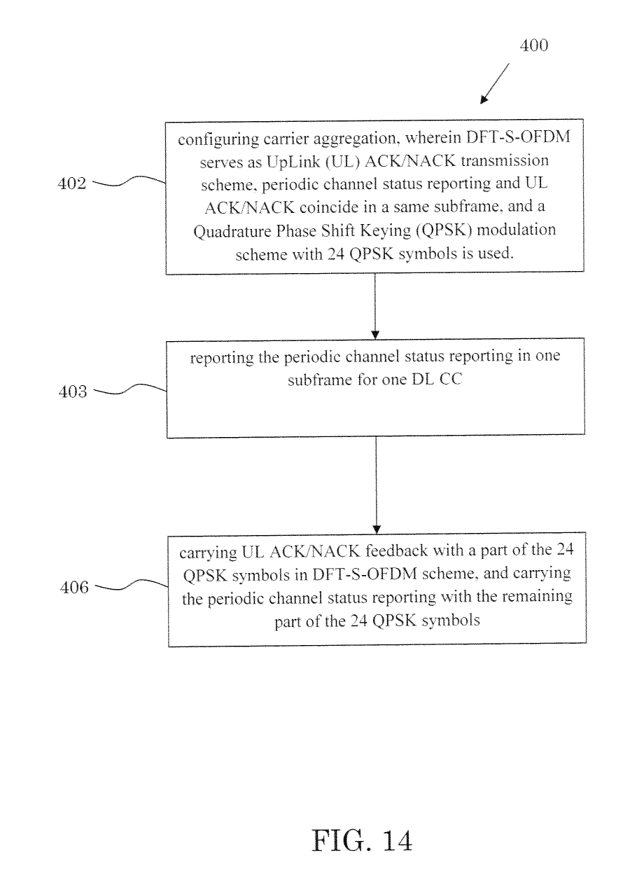

In another embodiment shown in FIG. 14, the method includes at 403, reporting the periodic channel status reporting in one subframe for one DL CC.

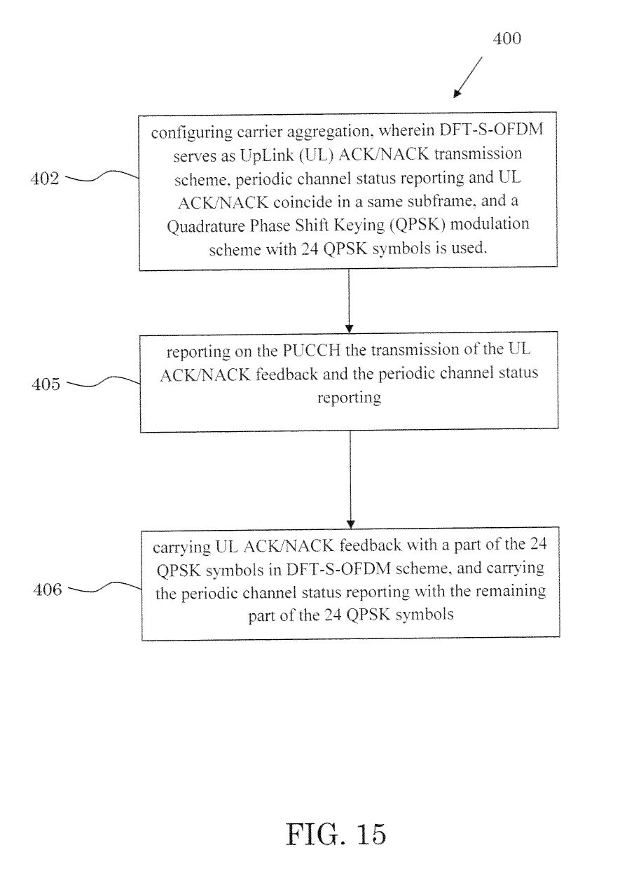

In another embodiment shown in FIG. 15, the method includes at 405, reporting on the PUCCH the transmission of the UL ACK/NACK feedback and the periodic channel status reporting.

Although a particular order of actions is illustrated in FIGS. 7-15, these actions may be performed in other sequences. For example, certain actions may be performed sequentially, concurrently, or simultaneously. Therefore, the methods and apparatus described herein are not limited to the above-described order of actions.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g. including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to Which the invention pertains.

What is claimed is:

1. A method of transmitting Acknowledgement/Negative-Acknowledgement (ACK/NACK) and periodic channel status reporting in a wireless communication system, the method comprising:
configuring carrier aggregation, wherein Discrete Fourier Transform-Spread-Orthogonal Frequency Division Multiple Access (DFT-S-OFDM) serves as UpLink (UL) ACK/NACK transmission scheme, periodic channel status reporting and UL ACK/NACK coincide in a same subframe, and a Quadrature Phase Shift Keying (QPSK) modulation scheme with 24 QPSK symbols is used: and
carrying UL ACK/NACK feedback with a part of the 24 QPSK symbols in DFT-S-OFDM scheme, and carrying the periodic channel status reporting with the remaining part of the 24 QPSK symbols.

2. The method of claim 1, further comprising using (20, O) block code for channel coding for both UL ACK/NACK bits and periodic channel status reporting bits.

3. The method of claim 1, further comprising rate matching channel-coded output bits of UL ACK/NACK feedback and periodic channel status reporting, respectively, according to their available number of QPSK symbols for transmission.

4. The method of claim 1, further comprising carrying the UL ACK/NACK feedback with 12 QPSK symbols, and carrying the periodic channel status reporting with the other 12 QPSK symbols.

5. The method of claim 4, further comprising carrying the QPSK symbols for UL ACK/NACK feedback on one slot, and the QPSK symbols for periodic channel status reporting on the other slot.

6. The method of claim 1, further comprising interleaving-mapping the QPSK symbols for UL ACK/NACK and the QPSK symbols for periodic channel status reporting to resource elements (REs) of each Single Carrier Frequency Division Multiple Access (SC-FDMA) symbol without reference signal.

7. The method of claim 1, wherein the channel status reporting is defined as CQI/PMI/RI reporting.

8. The method of claim 1, further comprising configuring via a higher layer an occasion of periodic channel status reporting.

9. The method of claim 1, further comprising reporting the periodic channel status reporting in one subframe for one DownLink (DL) Component Carrier (CC).

10. The method of claim 1, further comprising reporting on a Physical Uplink Control Channel (PUCCH) the transmission of the UL ACK/NACK feedback and the periodic channel status reporting.

11. A communication device for use in a wireless communication system, the communication device comprising:
a control circuit;
a processor installed in the control circuit for executing a program code to command the control circuit; and
a memory installed in the control circuit and coupled to the processor;
wherein to transmit Acknowledgement/Negative-Acknowledgement (ACK/NACK) and periodic channel status reporting, the processor is configured to execute a program code stored in memory to:
configure carrier aggregation, wherein Discrete Fourier Transform-Spread-Orthogonal Frequency Division Multiple Access (DFT-S-OFDM) serves as UpLink (UL) ACK/NACK transmission scheme, periodic channel status reporting and UL ACK/NACK coincide in a same subframe, and a Quadrature Phase Shift Keying (QPSK) modulation scheme with 24 QPSK symbols is used; and
carry UL ACK/NACK feedback with a part of the 24 QPSK symbols in DFT-S-OFDM scheme, and carry the periodic channel status reporting with the remaining part of the 24 QPSK symbols.

12. The communication device of claim 11, wherein the processor is further configured to execute the program code to use (20, O) block code for channel coding for both UL ACK/NACK bits and periodic channel status reporting bits.

13. The communication device of claim 11, wherein the processor is further configured to execute the program code to rate match channel-coded output bits of UL ACK/NACK feedback and periodic channel status reporting, respectively, according to their available number of QPSK symbols for transmission.

14. The communication device of claim 11, wherein the processor is further configured to execute the program code to carry the UL ACK/NACK feedback with 12 QPSK symbols, and carrying the periodic channel status reporting with the other 12 QPSK symbols.

15. The communication device of claim 14, wherein the processor is further configured to execute the program code to carry the QPSK symbols for UL ACK/NACK feedback on one slot, and the QPSK symbols for periodic channel status reporting on the other slot.

16. The communication device of claim 11, wherein the processor is further configured to execute the program code to perform interleaving-mapping the QPSK symbols for UL ACK/NACK and the QPSK symbols for periodic channel status reporting to resource elements (REs) of each Single Carrier Frequency Division Multiple Access (SC-FDMA) symbol without reference signal.

17. The communication device of claim 11, wherein the channel status reporting is defined as CQI/PMI/RI reporting.

18. The communication device of claim 11, wherein the processor is further configured to execute the program code to configure via a higher layer an occasion of periodic channel status reporting.

19. The communication device of claim 11, wherein the processor is further configured to execute the program code to report the periodic channel status reporting in one subframe for one DownLink (DL) Component Carrier (CC).

20. The communication device of claim 11, wherein the processor is further configured to execute the program code to report on a Physical Uplink Control Channel (PUCCH) the transmission of the UL ACK/NACK feedback and the periodic channel status reporting.
